(19) United States
(12) Patent Application Publication
(10) Pub. No.: US 2007/0065055 A1
(43) Pub. Date: Mar. 22, 2007

(54) Roller retainer module

(75) Inventor: Po-Lin Pan, Taichung (TW)

Correspondence Address: HDSL, 4331 STEVENS BATTLE LANE, FAIRFAX, VA, 22033, US

(73) Assignee: Hiwin Technologies Corp.

(21) Appl. No.: 11/228,274

(22) Filed: Sep. 19, 2005

(51) Int. Cl. F16C 19/00; A47B 88/00

(52) U.S. Cl. 384/51

(57) ABSTRACT

A roller retainer module includes an upper and lower thin boards disposed flush with each other, with a plurality of separated space each having a hexagonal cell structure, in which a corresponding roller is fixed in position. Since such cell structure may not exert a large friction force on the roller, the roller may be maintained with its direction changing function.

### BACKGROUND OF THE INVENTION

1. Field of the Invention

The present invention relates to a roller retainer module. More particularly, the present invention relates to a roller retainer used on a straight line transmission member which is used in such as a machine tool, an electronic device and an automatic apparatus.

2. Description of Related Art

A conventional roller chain can be referred to FIG. 7. As shown, the roller chain 41 has rollers 11 each disposed within a separated space 413. Between two linking chains 412b, a plurality of connection chains 412a are connected to form the elongate chain 41. On each of the connection chains 412a, at least a retainer 411 is formed. The retainer 411 is used to fix the roller 11 in position when the separated space 413 is rolled. In this roller chain 41, although the roller 11 may be fixed in position in directions, denoted as “Q” and “L”, the single retainer 411 may not fix the roller 11 in position in the vertical direction, causing the roller 11 easy to fall off and assembly of the chain 41 hard to be fixed. In the case of proceeding on a reflow path, the roller 11 may possibly come off from the separated space 413 when making a turn along the reflow path and thus gets stuck in the flow path.

A conventional retainer is featured in that a plurality of single entities are make into a connection body thereby, which is schematically shown in FIG. 8. As shown, separation pieces 511 are connected to one another through a connection chain 512. As such, each of the rollers 11 are rolled between two adjacent ones of the separation pieces 511 corresponding thereto. To assemble the separation pieces 511 together with the connection chain 512, a lot of labor work is required. Further, the roller 11 is also required of assembling work. Such an assembly task can be not easy and time consuming.

If it is intended to form a single body of the separation pieces 511 and connection chain 512, there is a problem if they are formed by using a mold. This is because that the separation piece 511 has concaved outer rims and thus the separation piece 511 may be interfered by a core of the mold and may not be taken out smoothly. If it is desired to separate the separation piece 511 from the mold, size of the separation piece 511 may be a problem and shape of the separation piece 511 may get deformed. Therefore, there is still a need to make an improvement upon such retainer.

FIG. 9 schematically shows a retainer chain for fixation of a roller. As shown, in the retainer chain 61 a connection chain 612 is connected to each of two sides of the separation board 611. Although this may be formed by using a mold, forming circular holes 613 on the separation board 611, mold design wise, requires to have a cylinder having a very small diameter and a great length introduced. When the separation board 611 is to be drawn out, the cylinder has to be removed first. In doing this, a complicated transmission mechanism is required.

However, it may be hard make the cylinder drawn out since the sample may wrap tightly the cylinder after being cooled and may become deformed. Further, the cylinder may also become deformed after several times of getting in and out. In addition, such a thin and long cylinder may possibly become deformed and broken when being subject to the injection force in the injection molding process. As a result, such roller retainer chain 61 is hard to be put under a mass production process and development of the mold requires a high cost and a complicated process. Therefore, there is an urgent need to set forth an improved retainer for the straight line transmission member.

In this regard, the Inventors have paid many efforts in the related research with respect to the shortcomings inherent in the prior art and finally developed successfully a roller retainer module, which is taken as the present invention.

### SUMMARY OF THE INVENTION

These features and advantages of the present invention will be fully understood and appreciated from the following detailed description of the accompanying Drawings.

Since straight line transmission members are widely used in general machinery and precision machinery industries and roller retainers are generally used in the straight line transmission member, such roller retainers have drawn many attentions, particularly the roller retainers having a connection design.

It is, therefore, an object of the present invention to provide a roller retainer module, which is manufactured by injection mold. With respect to manufacture of the roller retainer module, mold development concept is introduced and thus the roller retainer module may be mass produced in a rapid manner and reduced in cost.

It is another object of the present invention to provide a roller retainer module, in which a separation space is manufactured as a cellular form having a symmetric shape and an enhanced strength. The separation space may efficiently fix rollers in position and may not delimit direction changing of the rollers. As such, the rollers in the roller retainer module may be separately disposed and the rollers may bear a reduced resistance from the roller retainer module.

It is yet another object of the present invention to provide a roller retainer module, in which assembly concept is introduced, making formation of the roller retainer module easy and a proper length of the roller retainer module achievable. As such, the roller retainer module of different lengths may be obtained without the need of providing molds for different sizes of the roller retainer module.

According to the present invention, the roller retainer module used to retain a plurality of rollers therein is characterized in that an upper board and a lower board are comprised and assembled flush with each other on which a plurality of separated spaces each defined by an inclined plane extending through the upper board to the lower board are formed, one of the plurality of rollers being disposed in and fixed by each of the separated spaces.

### BRIEF DESCRIPTION OF THE DRAWINGS

FIG. 1 is a perspective view of a roller retainer module according to a first embodiment of the present invention;

FIG. 2 is a cross sectional view of the roller retainer module according to the first embodiment of the present invention;

FIG. 3 is an exploded view of the roller retainer module according to the first embodiment of the present invention;

FIG. 4 is another exploded view of the roller retainer module illustrating assembly thereof according to the present invention;

FIG. 5 is a schematic diagram of the roller retainer module having a unit length according to the present invention;

FIG. 6 is a schematic diagram of the roller retainer module assembled with two roller retainer modules shown in FIG. 5;

FIG. 7 shows schematically a conventional roller retainer module;

FIG. 8 shows schematically another conventional roller retainer module; and

FIG. 9 shows schematically yet another conventional roller retainer module.

### DETAILED DESCRIPTION OF THE PREFERRED EMBODIMENT

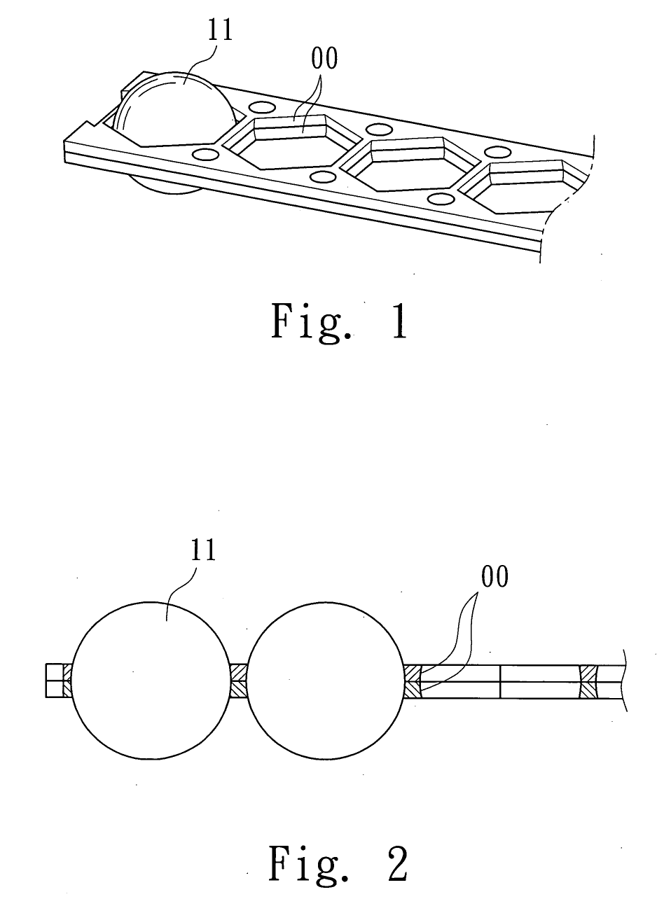

Referring to FIG. 1 and FIG. 2, a perspective view and cross sectional view of a roller retainer module according to a first embodiment of the present invention are shown therein. As shown, a roller 11 is fixed in position by a retaining and contacting surface 00 and thus refined in a hexagonal cell structure. Specifically, each roller 11 is fixed in the hexagonal cell structure tangent to the retaining and contacting surface 00. In this manner, a friction force between the roller 11 and retaining and contacting surface 00 may be efficiently reduced, enabling the roller 11 to maintain a direction changing ability. Although only a roller 11 is described, the used roller 11 may be more than one and all the rollers 11 are disposed in the same manner as that of the illustrated roller 11.

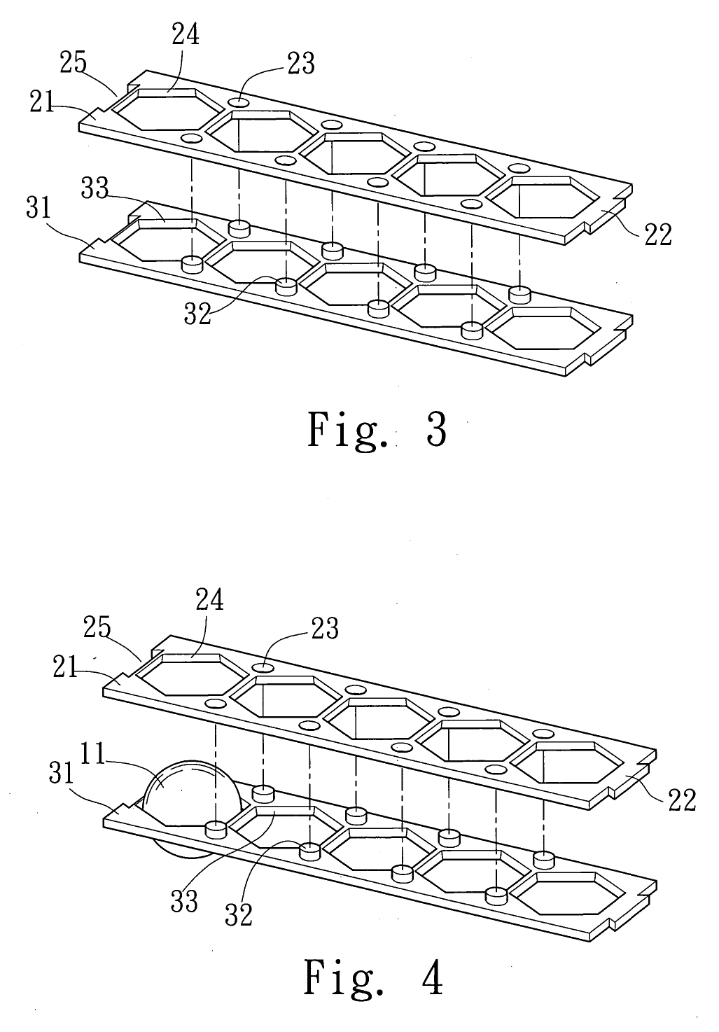

Such structure is generally expected to be manufactured in a single body by injection mold. However, this expectation is not viable in terms of development of the mold. This is because the thus-formed roller retainer module may not be smoothly separated from the mold due to the hexagonal retaining and contacting cell structure. Further, the roller 11 should then be assembled into the hexagonal cell structure with a force exerted and an improper force may bring a damage to the hexagonal cell structure. To exempt this from occurring, the roller retainer module is otherwise formed with an upper board 21 and a lower board 31, each having a unit length, which is shown in FIG. 3. This manufacturing regime has the following advantages.

First, the roller retainer module having an interior cavity structure may be separated from the mold based on a male and female cores configuration. As such, no complicated mold mechanism such as slider and angle pin is required, considerably reducing cost and prolonging lifetime of the used mold.

Second, the retaining and contacting surface 00 may be produced by a pearlite range so that the roller retainer module may be separated from the mold more easily and the design of the retaining and contacting surface 00 needs not to be modified. In addition, the peartile ranges 24,33 of the upper and lower boards may have different values so that the rollers 11 of different dimensions may be used therewith or different direction changing spaces may be obtained. This is particularly important when the roller 11 is used with a ball screw since not only a threading angle and a reflow angle should be considered in the ball screw and also a direction changing space having a very good degree of freedom should be preserved for the ball screw. As a result, the roller retainer module is considerably flexible in use and design.

Third, the roller 11 may be easy to be assembled into the roller retainer module. Referring to FIG. 4, the roller 11 is first placed on the lower board 31 manually or automatically and then the upper board 21 may be attached to the lower board 31 by aligning and connecting connection holes 23 on the upper board 21 to connection pin 32. Meanwhile, the roller retainer is easy to be taken in hand when the assembly task is conducted and the roller 11 is hard to fall off from the roller retainer module. As such, the problem that a single piece of the roller retainer module is hard to be assembled may be well addressed.

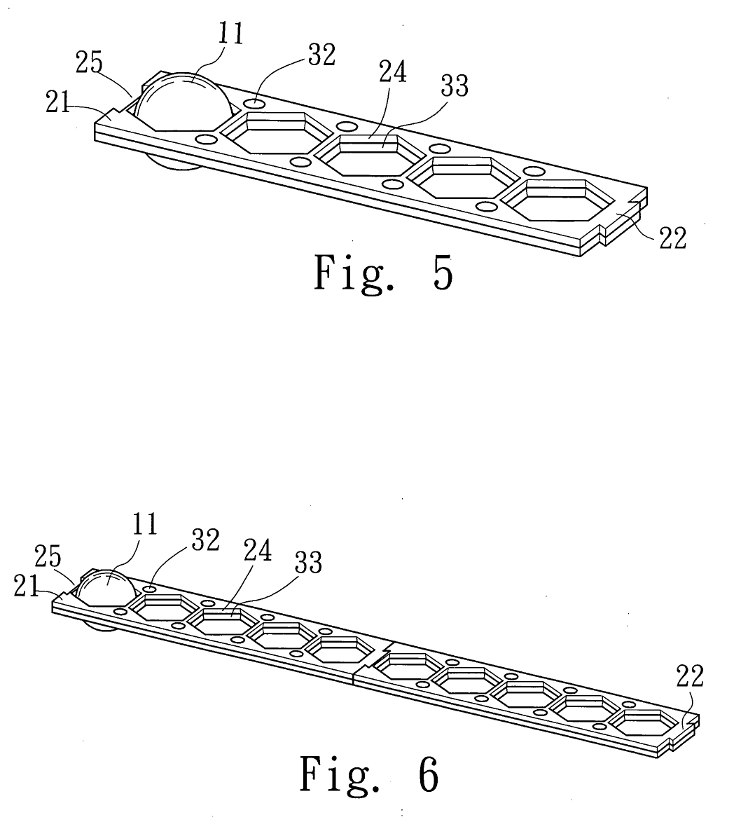

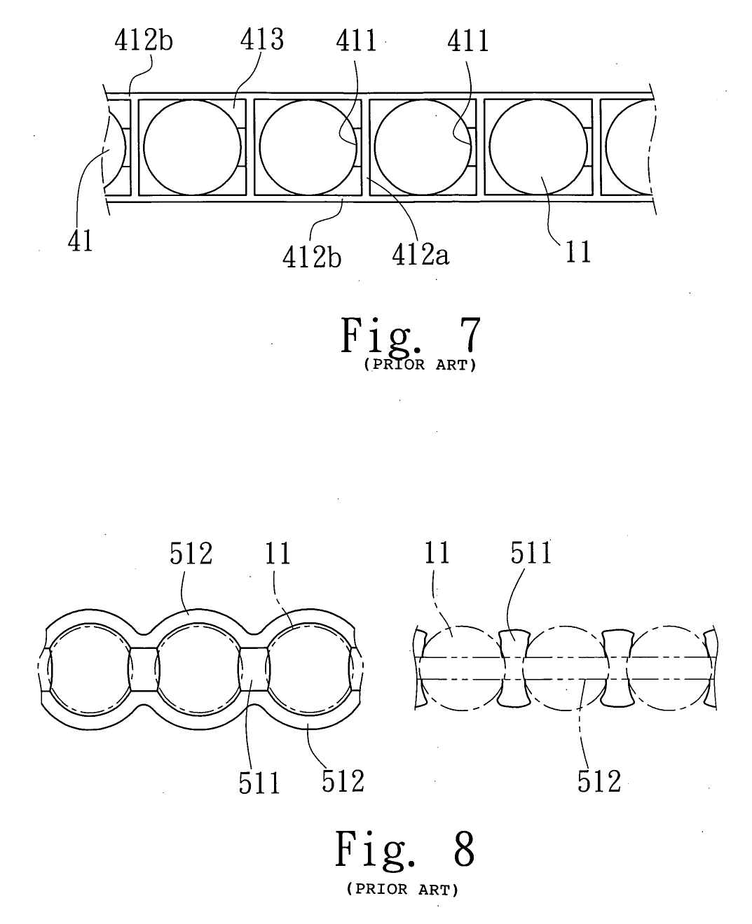

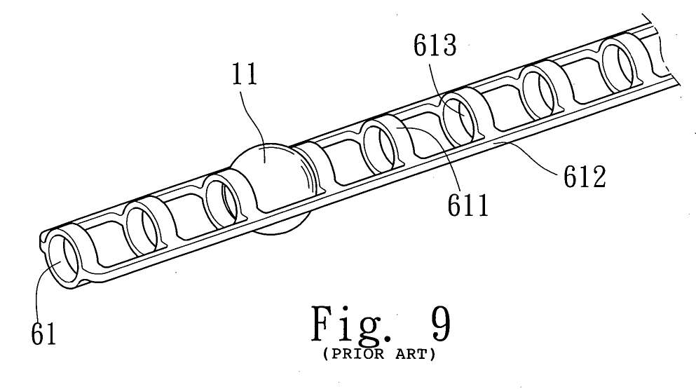

Fourth, a proper mold requires a high cost as generally known. If an additional mold is manufactured for a structure having a same structural feature, the cost can not be efficient. In view of this, the inventive roller retainer module is devised to be assembled with a plurality of roller retainer modules each having a unit length. Referring to FIG. 5, two such roller retainer module may be assembled together to form a longer roller retainer module of this kind by connecting a protrusion 22 disposed at one end of one such roller retainer module of unit length to an indentation 25 disposed at the other end of another such roller retainer module of unit length.

In addition, the roller retainer module may be formed with a wear-resisting and flexible material. As such, the roller retainer module may provide a better direction changing ability and prolonged lifetime.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A roller retainer module used to retain a plurality of rollers therein, the roller retainer comprising a upper board and a lower board assembled flush with each other on which a plurality of separated spaces each defined by an inclined plane extending through the upper board and the lower board are formed, one of the plurality of rollers being disposed in and fixed by a corresponding one of the separated spaces.

2. The roller retainer module according to claim 1, wherein one of the upper and lower boards has a connection hole and the other of the upper and lower boards has a connection pin so that the upper and lower boards are connected together by connecting the connection hole and connection pin.

3. The roller retainer module according to claim 1, wherein a protrusion and an indentation are disposed at two ends of the roller retainer module so that a plurality of the roller retainer modules, particularly the ones each having a unit length, may be connected in series.

4. The roller retainer module according to claim 1, wherein the inclined surface comprising an upper pearlite range and a lower peartile range which may be different from each other so that the roller has an optimal direction changing space in relation to the retaining and contacting surface.

5. The roller retainer module according to claim 1, wherein the separated space is a hexagonal structure.

6. The roller retainer module according to claim 1, wherein the roller is a ball.
